(19) United States
(12) Patent Application Publication
(10) Pub. No.: US 2022/0351219 A1
(43) Pub. Date: Nov. 3, 2022

(54) STORE USE INFORMATION DISTRIBUTION DEVICE, STORE USE INFORMATION DISTRIBUTION SYSTEM EQUIPPED WITH SAME, AND STORE USE INFORMATION DISTRIBUTION METHOD

(71) Applicant: PANASONIC INTELLECTUAL PROPERTY MANAGEMENT CO., LTD., Osaka (JP)

(72) Inventors: Keisuke SUETSUGI, Osaka (JP); Masataka SUGIURA, Tokyo (JP)

(73) Assignee: PANASONIC INTELLECTUAL PROPERTY MANAGEMENT CO., LTD., Osaka (JP)

(21) Appl. No.: 17/641,328

(22) PCT Filed: Aug. 26, 2020
(86) PCT No.: PCT/JP2020/032223

§ 371 Date: Mar. 8, 2022

(30) Foreign Application Priority Data
Sep. 9, 2019 (JP) 2019-163830

(51) Int. Cl. G06Q 30/02; G06V 40/16; G06V 10/26; G06Q 30/06

(52) U.S. Cl. CPC G06Q 30/0201; G06V 40/161; G06V 10/26; G06Q 30/0251; G06Q 30/0623; G06V 2201/07

(57) ABSTRACT

Provided is a system which enables a business operator that operates a physical store to identify each customer and acquire related store use information, without any need for management of customers' face images at each store. A store use information distribution device includes a processor and an action history storage for storing action history information about customers' actions in the store. The processor is configured to: acquire face images of customers; generate face image IDs for identifying the face images of the customers; transmit the IDs to a business operator device; perform a customer segmentation operation on action history information based on segmentation criteria related to customers' store usage, to thereby assign the customers to segments; and transmit a set of face IDs of customers assigned to certain segments to the business operator device as the store use information.

### TECHNICAL FIELD

The present disclosure relates to a store use information distribution device, a store use information distribution system equipped with the same, and a store use information distribution method for providing store use information about customers' usage of a physical store.

### BACKGROUND ART

In recent years, an increased number of consumers use virtual stores (online shops) on e-commerce (EC) websites on the Internet. Many consumers, who use such virtual stores, tend to come to physical stores only to check real items, and purchase the items not at the physical stores, but through virtual stores. Thus, a problem is that consumers tend not to purchase items at physical stores even when they visit those stores. Thus, there is a need to implement effective on-site measures which drive customers to visit physical stores in order to purchase, thereby promoting sales of items at the physical stores.

In the case of a virtual store on an EC website on the Internet, a store manager (e.g., a business operator who operates the virtual store) can relatively easily collect history data of individual customers' actions (such as purchase history and browsing history) based on, for example, customers' historical information stored in a server or a web browser. However in order to collect history data of individual customers' actions in a physical store, a store manager needs to have a customer show or present information carrying media (such as a membership card and a portable terminal device), for example, at the time of purchasing an item (or providing a service) or when the customer enters the store, which can lower customers' convenience compared to the case of virtual stores.

Known technologies for identifying a customer in a physical store without using information carrying media, include a device configured to extract a face feature representing the feature of a customer's face from a face image captured in a store, and acquire associated member information from membership information stored in a storage based on the extracted face feature (Patent Document 1).

### PRIOR ART DOCUMENT (S)

### Patent Document(s)

Patent Document 1: JP2011-048462A

### SUMMARY OF THE INVENTION

### Task to be Accomplished by the Invention

In the above-described prior art as disclosed in Patent Document 1, a store manager of a physical store needs to properly manage a face image (or face feature data) of each customer, which imposes an increased load of information management, which includes security measures, on each store's system. In addition, when a customer uses different physical stores (i.e. different business operators), customer's face images are captured and managed at the respective stores. This means that, the more physical stores the customer uses, the higher risk for face image information leaks.

The present disclosure has been made in view of these problems of the prior art, and a primary object of the present disclosure is to provide a store use information distribution device, a store use information distribution system equipped with the same, and a store use information distribution method, which enable a business operator that operates a physical store to identify each customer and acquire related store use information at the physical store, without any need for management of customers' face images at each store.

### Means to Accomplish the Task

An aspect of the present disclosure provides a store use information distribution device communicably connected to at least one business operator device for managing member information about customers of a physical store, and configured to provide the business operator device with store use information about customers' usage of the physical store, the store use information distribution device comprising: a processor; and an action history storage for storing action history information about actions of the respective customers in the physical store; wherein the processor is configured to: acquire face images of the respective customers; generate face image IDs for identifying the respective face images of the customers; transmit each of the face image IDs to the business operator device; perform a customer segmentation operation on the action history information based on one or more segmentation criteria related to the customers' usage of the physical store, to thereby assign the customers to one or more segments; and generate a set of face IDs of customers assigned to at least one of the segments and transmit the set of face image IDs to the business operator device as the store use information.

Another aspect of the present disclosure provides a store use information distribution system comprising: the store use information distribution device; and the at least one business operator device for managing the member information about the customers of the physical store.

Yet another aspect of the present disclosure provides a store use information distribution method, wherein the method is performed by a store use information distribution device communicably connected to at least one business operator device for managing member information about customers of a physical store, and configured to provide the business operator device with store use information about customers' usage of the physical store, the method comprising: storing action history information about actions of the respective customers in the physical store; acquiring face images of the respective customers; generating face image IDs for identifying the respective face images of the customers; transmitting each of the face image IDs to the business operator device; performing a customer segmentation operation on the action history information based on one or more segmentation criteria related to the customers' usage of the physical store, to thereby assign the customers to one or more segments; and generating a set of face IDs of customers assigned to at least one of the segments and transmitting the set of face image IDs to the business operator device as the store use information.

### Effect of the Invention

According to the present disclosure, a business operator that operates a physical store is enabled to identify each customer and acquire related store use information at the physical store, without any need for management of customers' face images at each store.

### BRIEF DESCRIPTION OF THE DRAWINGS

FIG. 1 is a diagram showing a general configuration of an information distribution system according to an embodiment of the present disclosure;

FIG. 2 is an explanatory diagram showing an outline of the information distribution system;

FIG. 3 is a functional block diagram showing a business operator server;

FIG. 4 is an explanatory diagram showing examples of records registered in (A) a member registration database, (B) a purchase history database, and (C) a sales promotion information database;

FIG. 5 is a functional block diagram showing an information distribution server 2;

FIG. 6 is an explanatory diagram showing examples of records registered in (A) a face image database, (B) a face feature database, (C) a face authentication history database, and (D) an action history database;

FIG. 7 is an explanatory diagram showing examples of records registered in (A) a store use database, and (B) an ID link database;

FIG. 8 is a flow chart showing flows of member registration operations performs by a customer terminal, a business operator server, and an information distribution server;

FIG. 9 is a flow chart showing flows of a modification of the member registration operations shown in FIG. 8;

FIG. 10 is an explanatory diagram showing an example of an opt-in screen used in step ST601 shown in FIG. 9;

FIG. 11 is a flow chart showing a flow of a face authentication history generation operation performed by an information distribution server;

FIG. 12 is a flow chart showing flows of operations for distribution of store use information from an information distribution server to a business operator server;

FIG. 13 is a flow chart showing flows of operations for action history information distribution from an information distribution server to a business operator server; and

FIG. 14 is an explanatory diagram showing an example of a customer segmentation operation performed by an information distribution server.

### DESCRIPTION OF THE PREFERRED EMBODIMENTS

A first aspect of the present disclosure made to achieve the above-described object is a store use information distribution device communicably connected to at least one business operator device for managing member information about customers of a physical store, and configured to provide the business operator device with store use information about customers' usage of the physical store, the store use information distribution device comprising: a processor; and an action history storage for storing action history information about actions of the respective customers in the physical store; wherein the processor is configured to: acquire face images of the respective customers; generate face image IDs for identifying the respective face images of the customers; transmit each of the face image IDs to the business operator device; perform a customer segmentation operation on the action history information based on one or more segmentation criteria related to the customers' usage of the physical store, to thereby assign the customers to one or more segments; and generate a set of face IDs of customers assigned to at least one of the segments and transmit the set of face image IDs to the business operator device as the store use information.

This configuration enables a business operator that operates a physical store to identify each customer and acquire related store use information at the physical store, without any need for management of customers' face images at each store. As a result, since the store use information distribution device can provide store use information to different business operator devices (operated by different business operators), there is no need to capture and manage face images of a customer at the respective stores, which minimizes risk for face image information leaks.

A second aspect of the present disclosure is the store use information distribution device of the first aspect, wherein the processor is configured to transmit the store use information to the business operator device in response to a transmission request from the business operator device.

In this configuration, the store use information distribution device can provide store use information to a business operator device with proper timing, in response to a transmission request from the business operator device.

A third aspect of the present disclosure is the store use information distribution device of the second aspect, wherein the transmission request includes a face image ID of at least one customer, and wherein the processor is configured to: extract at least one segment to which the at least one customer whose face image ID is included in the transmission request belongs, as a target segment; and transmit a corresponding set of face IDs of customers assigned to each target segment to the business operator device as the store use information.

In this configuration, since a set of face IDs of customers of the target segments extracted based on face image IDs (i.e. customers selected by the business operator) is transmitted to the business operator device as store use information, the store use information becomes more useful for the business operator (the business operator device).

A fourth aspect of the present disclosure is the store use information distribution device of the second or third aspect, wherein the transmission request includes a segmentation criterion ID for identifying the segmentation criterion, and wherein the processor is configured to perform the customer segmentation operation on the action history information based on a segmentation criterion corresponding to the segmentation criterion ID included in the transmission request.

In this configuration, since the segmentation criterion which corresponds to the segmentation criterion ID transmitted from the business operator device (i.e. segmentation criteria designated by the business operator) is used to determine a segment and a set of face IDs of the segment is transmitted to the business operator device as store use information, the store use information becomes more useful for the business operator (the business operator device).

A fifth aspect of the present disclosure is the store use information distribution device of any of the first to fourth aspects, wherein a customer terminal carried by a customer stores an application program for registration of the member information, and wherein the processor acquires a face image of the customer via the application program.

In this case, the store use information distribution device can acquire a face image of a customer with a simpler configuration.

A sixth aspect of the present disclosure is the store use information distribution device of any of the first to fourth aspects, wherein a camera is installed in the physical store, and is configured to capture face images of the customers.

In this case, the store use information distribution device can acquire a face image of a customer, without any need for the customer's operation on any device.

A seventh aspect of the present disclosure is t the store use information distribution device of any of the first to sixth aspects, wherein the processor transmits the store use information only to a permitted business operator device which is selected by a customer from the at least one business operation device, and to which the store use information is permitted to transmitted.

In this configuration, even when store use information is transmitted to a plurality of business operator devices, customers' information (image IDs and store use information) can be prevented from being transmitted to any of the business operator devices against the customers' intention.

An eighth aspect of the present disclosure is a store use information distribution system comprising: the store use information distribution device; and the at least one business operator device for managing the member information about the customers of the physical store.

This configuration enables a business operator that operates a physical store to identify each customer and acquire related store use information at the physical store, without any need for management of customers' face images at each store.

A ninth aspect of the present disclosure is the store use information distribution system of the eighth aspect, wherein the business operator device, based on the store use information, distributes sales promotion information which can increase purchase motivation of a target customer, to at least one of a customer terminal carried by the target customer and a staff terminal carried by a staff member of the physical store.

In this configuration, a business operator device (i.e. a business operator) is enabled to distribute proper sales promotion information based on the store use information to each customer (or each staff member at a physical store), without any need for management of customers' face images at each store.

A tenth aspect of the present disclosure is the store use information distribution system of the eighth or ninth aspect, further comprising a touchpoint terminal which is installed in the physical store so that the customers can use the touchpoint terminal, and wherein the action history information includes touchpoint information indicating that the customers use the touchpoint terminal to view and check information on a specific item or a specific service.

This configuration enables the store use information distribution system to distribute effective sales promotion information to customers based on accurate real-time store visit information.

An eleventh aspect of the present disclosure is a store use information distribution method, wherein the method is performed by a store use information distribution device communicably connected to at least one business operator device for managing member information about customers of a physical store, and configured to provide the business operator device with store use information about customers' usage of the physical store, the method comprising: storing action history information about actions of the respective customers in the physical store; acquiring face images of the respective customers; generating face image IDs for identifying the respective face images of the customers; transmitting each of the face image IDs to the business operator device; performing a customer segmentation operation on the action history information based on one or more segmentation criteria related to the customers' usage of the physical store, to thereby assign the customers to one or more segments; and generating a set of face IDs of customers assigned to at least one of the segments and transmitting the set of face image IDs to the business operator device as the store use information.

This configuration enables a business operator that operates a physical store to identify each customer and acquire related store use information at the physical store, without any need for management of customers' face images at each store.

Embodiments of the present disclosure will be described below with reference to the drawings.

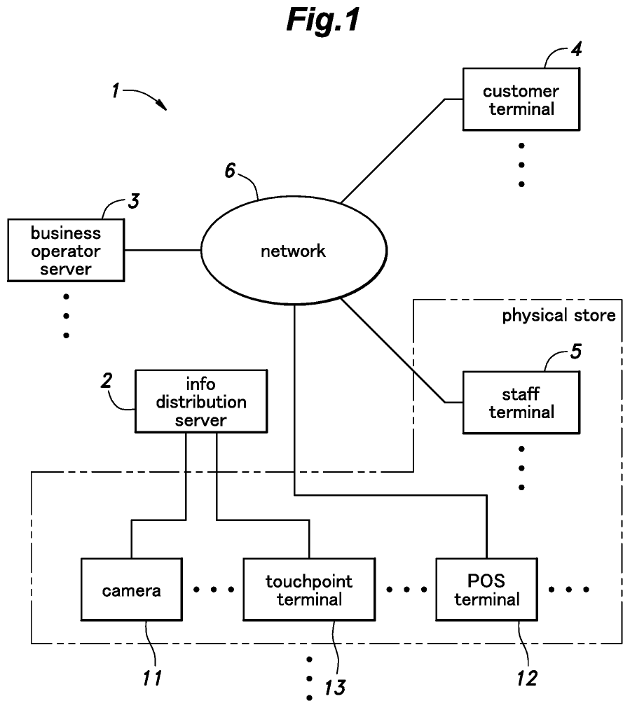

FIG. 1 is a diagram showing a general configuration of an information distribution system (store use information distribution system) according to an embodiment of the present disclosure.

The information distribution system 1 is used by business operators (i.e. business operator servers 3) which sell items and/or provide services to customers who use multiple physical stores (existing stores), and configured to provides store use information about each customer's usage of a physical store (hereinafter referred to as “store usage information”) to those business operators. Business operators such as retailers identify customers based on the received store use information and perform various operations for the identified customers, e.g., issue coupons usable at physical stores (such as electronics retail stores), and/or instruct staff members (store staff) to serve customers who visit physical stores, thereby promoting sales of items at the physical stores.

The term “customers” refers to persons including not only customers who purchase items and services in physical stores (particularly, regular customers), but also potential customers who may purchase items and services in physical stores. The term “business operators” refers to business operators that are not limited to those operating physical stores, but may include other related business operators including a business operator that advises marketing of items and services handled in the physical store, a business operator that manufactures items, and a business operator that produces advertisements for items and services.

The information distribution system 1 includes an information distribution server (store use information distribution device) 2, a business operator server(s) (business operator device) 3, a customer terminal(s) 4, and a staff terminal(s) 5. These servers and terminals are connected to a known network (such as Internet or LAN) 6 and can communicate with each other as necessary.

As will be described later, the information distribution server 2 manages information related to face images of customers who use physical stores, and distributes customers' store usage information to at least one business operator server 3.

The business operator server 3 is a server operated by a business operator who operates a physical store (usually a plurality of stores). The business operator server 3 manages member information registered by customers who use physical stores. At least customer's face images and face features are not included in the member information managed by the business operator server 3.

The business operator server 3 distributes sales promotion information for increasing purchase motivation of customers to a customer terminal 4 and/or a staff terminal 5 based on store use information distributed from the information distribution server 2.

The customer terminal 4 is a mobile terminal device carried by a customer, and includes, for example, a smartphone, a tablet terminal, a PC, or and other terminal device. A dedicated application program for using physical stores is installed on the customer terminal 4 with the customer's consent (hereinafter referred to as “store use application”). In addition, a dedicated application program for using the information distribution server 2 (e.g., managing personal information such as face images) can be installed on the customer terminal 4 with the customer's consent (hereinafter referred to as “information management application”). The staff terminal 5 is a mobile terminal device carried by a staff member and includes, for example, a smartphone, a tablet terminal, a PC, or and other terminal device like the customer terminal 4.

Although not shown, the information distribution server 2, the business operator server 3, the customer terminal 4, and the staff terminal 5 each have known computer hardware components such as a processor, a memory, an input device (e.g., a keyboard), and an output device (e.g., display, or speaker), and their functions are implemented by the respective processors executing predetermined control programs.

The information distribution system 1 includes a camera(s) 11, a POS terminal(s) 12, and a touchpoint terminal(s) 13. Each of these devices is communicably connected to the information distribution server 2 via a communication network (not shown) in the physical store or the above-mentioned network 6 as necessary. The information distribution server 2 can also transmit and receive information and data to and from the camera 11 and the touchpoint terminal 13 via other information processing devices (such as PC and server). The business operator server 3 can also transmits and receive information and data to and from the POS terminal 12.

The camera 11 is installed at any proper place in the store, specifically, at the entrance/exit of the store, around a display shelf, or at any other suitable place. Images captured by the camera 11 are transmitted to the information distribution server 2.

The POS terminal 12 is installed at a proper place in the store, specifically, at a cashier counter where customers pay for items. Purchase information entered at the POS terminal 12 is transmitted to the business operator server 3.

The touchpoint terminal 13 is installed at a proper place in the store, specifically, at the entrance/exit of the store. In some cases, the touchpoint terminal 13 is provided at place outside the store, such as in a railway station or any other suitable place.

The touchpoint terminal 13 transmits ID signals to the customer terminal 4 through visible light communications. The customer terminal 4 acquires a URL of a website corresponding to the received ID signal, and accesses the website using the acquired URL, enabling users to view information on items in the website. The customer information acquired associated with the touchpoint terminal 13 is transmitted to the information distribution server 2.

The touchpoint terminal 13 may be a dedicated device, a digital signage device which displays ad contents or other information, or an electronic shelf label placed on a display shelf and configured to display a price or other information and have a visible light communication function.

In the present embodiment, the touchpoint terminal 13 uses visible light communications to transmit necessary information such as a URL of a website to the customer terminal 4. However, usable information transmission methods are not limited to visible light communications, and may include use of machine-readable 2D codes and non-contact communications such as NFC (near field communication).

Although only one information distribution server 2 is shown in FIG. 1, a plurality of servers may cooperate to implement the functions (perform various processing operations) of the information distribution server 2. In addition, the information distribution system 1 may use another information processing device having similar functions to the information distribution server 2, instead. With regard to the cooperation of the multiple servers and the use of another information processing device, the same applies to the business operator servers 3. Although, in the present embodiment, various servers, various terminals, cameras, and other components are connected to each other via a network to transfer necessary information to each other, a proper storage medium may be used to transfer information and data from one device to another.

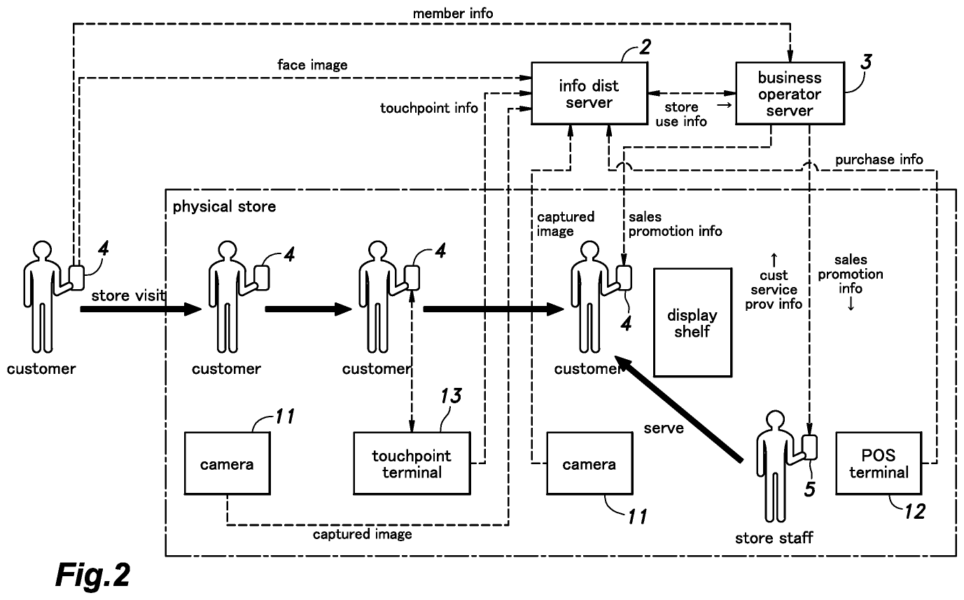

FIG. 2 is an explanatory diagram showing an outline of the information distribution system 1.

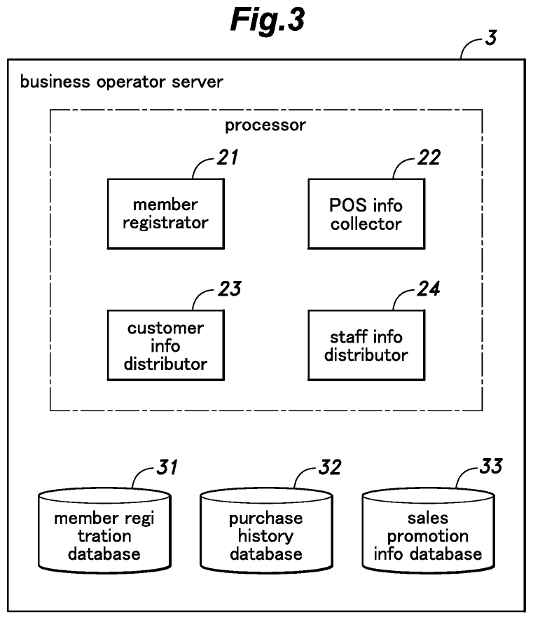

When a customer uses a physical store, the customer accesses the business operator server 3 from the customer terminal 4 to register themselves as a member (membership registration). When performing the member registration, the customer can enter customer information by activating the store use application on the customer terminal 4 and having a predetermined information entry screen displayed. The entered customer information is transmitted to the business operator server 3 and registered in the member registration database 31 (see FIG. 3) as member information.

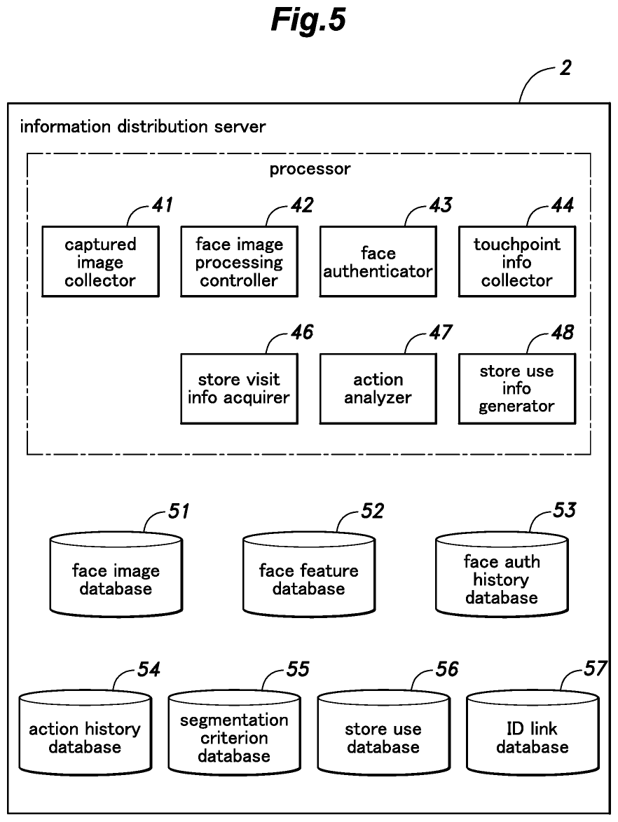

When performing the membership registration using the store use application, a customer can register their face image from the information management application. The customer face image data entered using the information management application is transmitted from the customer terminal 4 to the information distribution server 2. Then, the face image data is registered in a face image database 51 (see FIG. 5) of the information distribution server 2. An application link between the store use application and the information management application may be used to enable the former to call the latter, or enable a customer to call the information management application through a menu screen of the store use application. In other cases, the customer terminal 4 may be configured such that a customer can manually activate the respective applications.

Customers visit a physical store to purchase items (or services), or only to check real items of their interest. When a customer visits a store, a camera 11 installed at the entrance of the store captures a picture image(s) of the customer. In addition, the customer can perform a touch interaction with the touchpoint terminal 13 provided near the entrance of the store in order to obtain store-entry coupon points (coupon points that can be used for shopping at the store and getting discounts on items).

Next, when the customer browses in the store to find a touchpoint terminal 13 associated with an item of interest, the customer can perform a touch interaction with the touchpoint terminal 13, and upon receiving a URL of a website delivered in response to the touch interaction, the customer can view the website of the received URL using the customer terminal 4.

Also, when the customer browses in the store to come in front of a shelf which displays an item of interest, the customer can make a stop there and perform in-front-of-shelf actions (such as taking an item from the shelf, returning an item to the shelf, and checking an item for selection). When such an event occurs in front of a shelf, a camera 11 provided near the shelf captures a picture image(s) of the customer.

Next, when the customer decides to purchase the item, the customer pays for the item at a cashier counter. When the payment is made, a store staff member enters information on the item to the POS terminal 12.

The information distribution server 2 performs face authentication based on picture images captured by the camera 11 at the entrance of the store to thereby detect a store visit of the customer, and generates real-time store visit information. Therefore, the camera 11 at the entrance of the store functions as a sensor for detecting store visits of customers. Furthermore, the information distribution server 2 performs an action analysis based on the picture image captured by the camera 11 in the sales floor to detect customers' in-front-of-shelf actions (such as taking an item from the shelf, returning an item to the shelf, and checking an item for selection), thereby generating in-store action information. Furthermore, the information distribution server 2 collects touchpoint information on each user's use of the touchpoint terminal 13 from the touchpoint terminal 13. In particular, the information distribution server 2 detects a customer's visit by a customer's touch interaction with the touchpoint terminal 13 near the store entrance and generates real-time store visit information. Thus, the touchpoint terminal 13 near the entrance of the store functions as a sensor for detecting store visits of customers.

The information distribution server 2 collects various types of information from the camera(s) 11 and the touchpoint terminal(s) 13, integrates the collected information for each person, and stores the information in the server as action history information.

As will be described later, the information distribution server 2 performs a processing operation such as (statistical processing) on the integrated action history information for each customer, and performs a segmentation operation on the integrated action history information based on one or more segmentation criteria related to usage of a physical store. In this way, the information distribution server 2 assigns each customer to one or more segments. Moreover, the information distribution server 2 transmits a set of face IDs (face identifiers) of customers belonging to (assigned to) a certain segment(s), to the business operator servers 3 as store use information.

The business operator server 3 extracts customers who are likely to purchase items from all the members (the registered customers), based on the store use information received from the information distribution server 2, and distributes sales promotion information that can increase purchase motivation of the extracted customers, to customer terminals 4 and/or staff terminals 5. In the present embodiment, coupons and information on specific items (or services) can be distributed to the customer terminal 4 as sales promotion information for customers. When a staff member needs to serve a customer at a physical store, the business operator server 3 can distribute a customer service instruction to the staff terminal 5 as sales promotion information for staff members.

The system may be configured such that, when the provision of services to a customer is completed, a store staff member enters information indicating that the staff has served the customer (customer service provision information) into the staff terminal so that the entered information is transmitted to the information distribution server 2. Then, the customer service provision information is registered in a database in the information distribution server 2. This configuration enables evaluation of the effect of staffs' services by comparing between occurrence of customer's purchase in the case with staffs services and that in the case without staffs services.

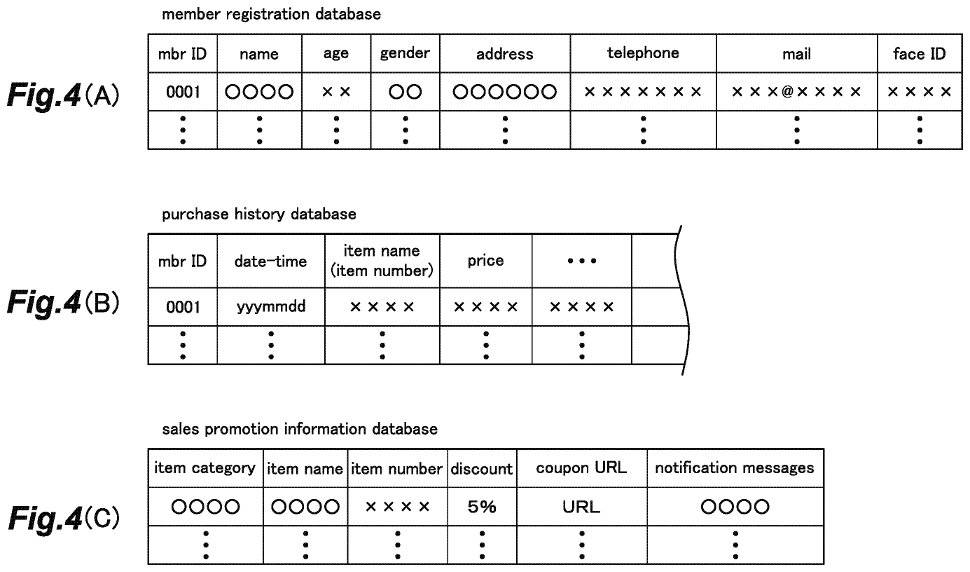

FIG. 3 is a functional block diagram showing a business operator server 3. FIG. 4 is an explanatory diagram showing examples of records registered in (A) a member registration database 31, (B) a purchase history database 32, and (C) a sales promotion information database 33.

The business operator server 3 includes a member registrator 21, a POS information collector 22, a customer information distributor 23 for customers, a staff information distributor 24 for staff members, a member registration database 31, a purchase history database 32, and a sales promotion information database 33.

The member registrator 21 acquires customer information from a customer terminal 4 and registers the information in the member registration database 31 as member information.

The member registration database 31 manages customer information. As shown in FIG. 4(A), the customer information database 31 stores registered data records of each customer such as member ID, name, age, gender, address, telephone number, e-mail address, and face ID (face image ID). The member ID is an identifier of a customer as a member and is generated (i.e. assigned to the customer) at the time of the membership registration. The face ID is an identifier of the customer's face image, and is acquired from the information distribution server 2 separately from the information acquired from the customer terminal 4 (such as name). These identifiers complement the member information provided from the customer terminal 4 and registered in the member registration database 31.

The POS information collector 22 acquires information records of purchases at physical stores (or virtual stores) of a customer registered as a member, and registers the information records in the purchase history database 32. The purchase history database 32 manages purchase history information records of the customer, and as shown in FIG. 4(B), contains registered data records such as a member ID, a date and time of purchase, a name of a purchased item (item number), and a price of the item. The POS information collector 22 can collect purchase information records of each customer from the POS terminal 12 and register the information records in the purchase history database 32 as purchase history information. The purchase history information may include the number of the POS terminal 12, information on use of a coupon (whether or not a coupon was used), and other information.

The POS information collector 22 can also use purchase history information records of each customer at an EC website (virtual store) operated by the business operator as the purchase history information.

Based on the store use information distributed from the information distribution server 2, the customer information distributor 23 generates sales promotion information for customers and distributes the information to customer terminals 4 carried by customers. The customer information distributor 23 may acquire information indicating that a target customer is visiting a physical store (e.g., the face ID of the target customer) from the information distribution server 2 and distribute sales promotion information for the target customer in the store. In the present embodiment, the customer information distributor 23 distributes coupons (such as discount coupons, complimentary tickets, and free service tickets) to the customer terminal 4 as the sales promotion information for the customer, where the coupons distributed to the customer are associated with one or more items which the customer is predicted to purchase (items which the customer is likely to have a high motivation to purchase).

The customer information distributor 23 may be configured to distribute a message with a recommendation of an item to a customer (item recommendation information) to the customer terminal 4 separated from, or together with coupons.

In addition, coupons to be distributed are preferably a coupon offering a limited user discount rate for a target customer and/or an in-store coupon offering a limited time discount, such as one which is available one day only and can be used only in the store a customer is currently visiting. As a result, it becomes possible to effectively increase purchase motivation of customers and drive the customers to make purchase decisions at the store they are currently visiting.

Instead of providing coupons, the customer information distributor 23 may offer a target customer a discounted price of a recommended item for the target customer. Specifically, the customer information distributor 23 may be configured to distribute a discount offer message to a customer terminal 4 in a similar manner to distribution of coupons. Alternatively, based on the location information of a customer (customer terminal 4), the customer information distributor 23 may be configured to distribute a discounted price of a recommended item to electronic point-of-purchase displays, signage or any other indicator device (not shown) in front of, or near the target customer to thereby cause the indicator device to display the discounted price, or the customer information distributor 23 may cause an electronic shelf label for a recommended item to display a discounted price of the item for the target customer, thereby offering the discounted price only to the target customer. In this case, the customer information distributor 23 can identify a target customer based on, for example, the ID data of a customer terminal 4.

When different discount prices of a certain item are offered to different customers, each discounted price needs to be connected to a corresponding customer for which the price is presented. In order to make this connection in practice, for example, the customer terminal 4 may include application software which enables a user to purchase and make payment when a discounted price is presented to the user, or the customer terminal 4 may be configured to display a discounted price of an item for a user and enable the user to interact with the customer terminal 4 so as to indicate the user's intention to purchase the produce at the discounted price (the user's agreement on the price), followed by making payment at a checkout counter. In order to enable the payment at a checkout counter, the customer terminal 4 may be configured, for example, to transmit a member ID of the customer to a payment system of a POS checkout counter when the user interacts with the customer terminal 4 to indicate the intention to purchase, and then, at the POS checkout counter, after acquiring the member ID of the customer from the customer terminal 4, the payment system checks the acquired member ID against the member ID which has already received, so as to enable the user to make payment at the agreed discounted price.

A discounted price may be determined in consideration of a level of the customer's demand for an item estimated from the customer's past action history information, as well as an amount of stock, an amount of purchase, and an amount of production of the item and other factors related thereto. (For example, when a level of the customer's demand is high and an amount of stock is decreased, a discount rate is determined to be lower, while when a level of the customer's demand is low and an amount of stock is increased, a discount rate is determined to be higher.)

The staff information distributor 24 generates sales promotion information for store staff based on store use information distributed from the information distribution server 2, and distributes the information to staff terminals 5. In the present embodiment, the staff information distributor 24 distributes instruction information to staff terminals 5 as sales promotion information for store staff, the instruction information instructing a staff member to serve the target customer.

The sales promotion information for store staff may include item information which notifies store staff of items which a target customer has shown high motivation to purchase, such as items which the customer has viewed on a website in the past. The staff information distributor 24 may be configured to acquire the current location of a target customer based on the location information of the customer (customer terminal 4), and notify store staff of the current location of the target customer. In this case, the staff terminal 5 is preferably configured to display a screen showing the customer's location on the area map of the store, and the staff information distributor 24 can identify a target customer or a staff member based on the IDs of the customer terminal 4 or the staff terminal 5, for example.

The staff information distributor 24 may determine, based on store use information, a suitable customer service method which is likely to increase the customer's purchase motivation, and notify store staff of the determined customer service method along with a customer service instruction to instruct the store staff to serve the target customer.

The sales promotion information database 33 manages sales promotion information that has distributed to customer terminals 4 and staff terminals 5. As shown in FIG. 4(C), the sales promotion information database 33 contains registered data records such as item information (item category, item name, item number), information about coupons (discount rate, URL of websites showing the barcode of a coupon), and information about notification messages included in the sales promotion information. The sales promotion information database 33 may contain information about customers who have been determined to need to be served by store staff.

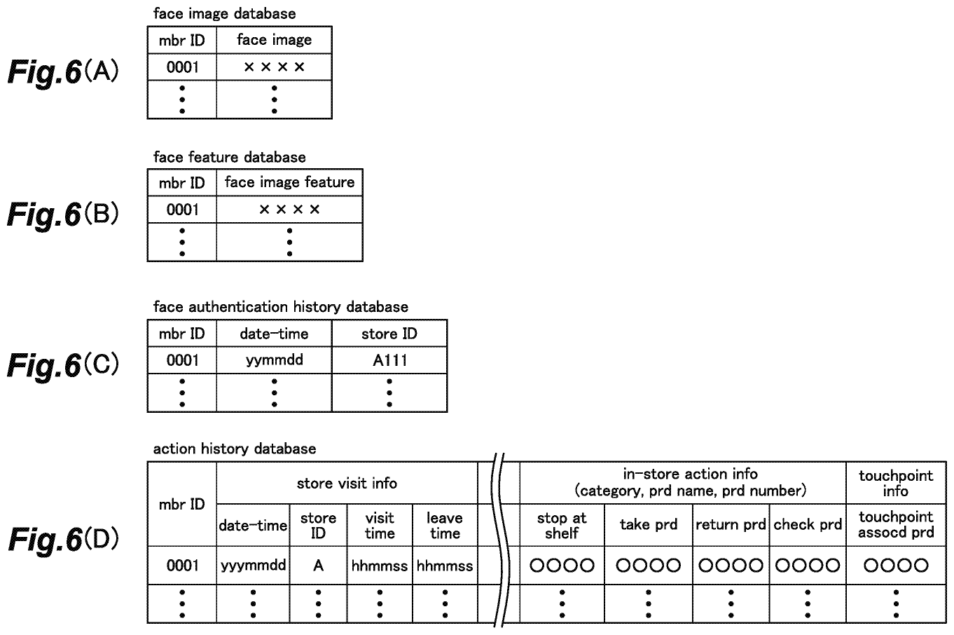

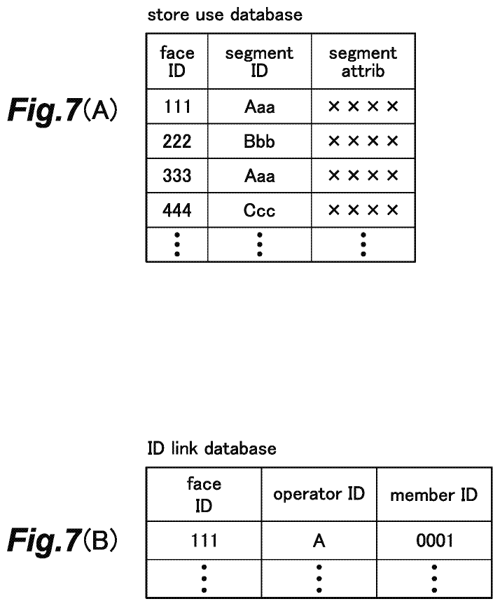

FIG. 5 is a functional block diagram showing an information distribution server 2. FIG. 6 is an explanatory diagram showing examples of records registered in (A) a face image database, (B) a face feature database, (C) a face authentication history database, and (D) an action history database. FIG. 7 is an explanatory diagram showing examples of records registered in (A) a store use database, and (B) an ID link database.

As shown in FIG. 5, the information distribution server 2 includes a captured image collector 41, a face image processing controller 42, a face authenticator 43, a touchpoint information collector 44, a store visit information acquirer 46, an action analyzer 47, a store use information generator 48, the face image database 51, a face feature database 52, a face authentication history database 53, an action history database (action history storage) 54, a segmentation criterion database 55, a store use database 56, and an ID link database 57. The face image database 51 is not essential, and the information distribution server 2 may include only the face feature database 52. In this case, the information distribution server 2 temporarily holds a face image, and deletes it after the extraction of a face feature from the face image. As will be described later, the information distribution server 2 may be configured without the ID link database 57 in some cases.

The captured image collector 41 collects the face image extracted from a captured image of a customer, and registers the extracted face image in the face image database 51. As shown in FIG. 6(A), items registered in the face image database 51 for each customer include a member ID, a customer's face image, and other data. The extraction of face images from captured images may be executed by the camera 11.

The face image processing controller 42 extracts a face feature from the customer's face image collected by the captured image collector 41, and registers the face feature in the face feature database 52. As shown in FIG. 6(B), items registered in the face feature database 52 for each customer include a member ID, face feature data extracted from the customer's face image, and other data.

The face authenticator 43 performs face authentication (personal authentication) on captured picture images provided from the camera 11 referring to the face image database 51 or the face feature database 52. The face authenticator 43 can acquire the member ID of a customer who has visited the store (that is, it can identify the customer) through face authentication. Furthermore, the face authenticator 43 registers a face authentication result (in the present embodiment, only when the member ID has been acquired) in the face authentication history database 53. As shown in FIG. 6(C), items registered in the face authentication history database 53 for each customer include a member ID, a date and time of face authentication, a store ID at which the face image was captured, and other data.

By identifying the customer through such face authentication, the information distribution server 2 can collect action history data of the identified customer.

The touchpoint information collector 44 collects touchpoint information acquired by a touchpoint terminal 13 in response to a user's touch interaction with the touchpoint terminal 13, and registers the collected touchpoint information in the action history database 54 as part of the customer's action history data. Each piece of touchpoint information is linked with a certain customer (member information) based on the member ID (or the ID of a customer terminal 4) acquired when the customer performs a touch operation on the touchpoint terminal.

When the POS information collector 22 (see FIG. 3) is included in the information distribution server 2, the system may be configured such that customer purchase information for each customer is collected from the POS terminal 12 and the corrected information is registered in the action history database 54 as part of the action history data.

The store visit information acquirer 46 acquires customer's store visit information in a physical store and registers the acquired information in the action history database 54. The store visit information acquirer 46 acquires store visit information based on a face authentication result of the face authenticator 43 (or through analysis of an image captured by the camera 11). In the present embodiment, the store visit information acquirer 46 acquires a date of store visit, a store ID, and a store visit time, as store visit information for each customer. Moreover, the store visit information acquirer 46 detects a customer leaving the store based on an authentication result provided by the face authenticator 43, and acquires a store leave time.

The action analyzer 47 detects actions of persons in picture images captured by the camera 11, acquires in-store action information on actions of customers in the store, and registered in the action history database 54 as part of the action history data. Specifically, the action analyzer 47 detects that a customer makes a stop in front of a shelf, and also detects that a customer performs actions such as taking an item from the shelf, returning an item to the shelf, and checking an item for selection. In addition, the action analyzer 47 acquires, based on the location where a customer (a customer terminal 4) makes a stop and the position of the customer's hand, item information (such as an item category, an item name, and an item number) related to an item for which the customer's action occurs; that is, an item of the customer's interest.

The action history database 54 manages action history information for each customer. As shown in FIG. 6(D), the action history database 54 stores registered data records for each customer such as a member ID, store visit information, in-store action information, and touchpoint information. The store visit information for each customer includes a date and time, a store ID, a store visit time, and a store leave time. The in-store action information for each customer includes information on items for which customer's actions occur, and information on the customer's actions (including making a stop in front of a store shelf, taking an item from a store shelf, returning an item to the shelf, and checking an item for selection). The touchpoint information for each purchase includes information on an item associated with a touchpoint terminal 13. When the information distribution server 2 is configured to acquire customer purchase history information, the customer purchase history information for each purchase includes, for example, the number of a POS terminal 12, information on use of a coupon (whether or not a coupon is used), and information on the purchased item (item name (item number), price).

The store use information generator 48 performs a customer segmentation operation on the customer's action history information registered in the action history database 54. The segmentation criterion database 55 stores one or more registered segmentation criteria. The store use information generator 48 can perform a customer segmentation operation based on segmentation criteria, to thereby assign each customer to one or more segments (a group of customers classified based on the similarity with respect to a subject segmentation criterion). Examples of criteria used as segmentation criteria include patterns of the date and time of each customer's store visits for multiple physical stores, and frequencies of store visits to the respective stores (e.g., an average number of store visits each month). When the information distribution server 2 estimates attributes such as age and gender from a face image and acquires the attributes as action history information, attributes such as age and gender can also be used as criteria for segmentation. For example, possible segments include a segment of persons who visited a specific store within the last week at the age of XX and picked up an item YY (i.e., had an interest). Furthermore, the information distribution server 2 can share information on segmentation criteria with business operator servers 3.

The store use information generator 48 registers the result of a customer segmentation operation in the store use database 56 for each segmentation criterion. As shown in FIG. 7(A), items registered in the store use database 56 for each store visit include a customer's face ID, a segment ID, a segment attribute, and other data. A segment ID is an identifier for identifying each segment with regard to a certain segmentation criterion. A segment attribute indicates the characteristics and properties of each segment. A result of a customer segmentation operation as shown in FIG. 7(A) is generated for each segmentation criterion.

In response to a transmission request from the business operator server 3 (or at a predetermined timing regardless of transmission requests), the store use information generator 48 can extract store use information from a result of a segmentation operation registered in the store use database 56 and distribute the extracted information to the business operator server 3. Specifically, when a transmission request (including face IDs) from the business operator server 3 designates one or more customers, the store use information generator 48 extracts face IDs corresponding to customers having the same segment ID as the designated customers, from the store use database 56 and generates a set of the extracted face IDs as store use information.

For example, in the example shown in FIG. 7(A), when a customer having a face ID “111” is designated by a transmission request from the business operator server 3, the face ID “333” having the same segment ID “Aaa” (that is, belonging to the same segment) is also incorporated into a set of face IDs generated as store usage information. Although details are not described here, the set of face IDs generated as store usage information usually includes more face IDs having the same segment ID; that is, the face ID “111”, in addition to the face ID “333.”

The store use information generator 48 can distribute store use information only to business operator servers 3 substantially operated by one business operator. In this case, the information distribution server 2 does not need the ID link database 57. The business operator server 3 can link each face ID, which is acquired as store use information from the information distribution server 2, to a corresponding member ID in the member registration database 31.

As will be described in detail later, the store use information generator 48 can distribute store use information to business operator servers 3 operated by a plurality of different business operators. In this case, the store use information generator 48 can determine whether or not to distribute store use information to a business operator server 3 based on ID link information, which indicates a link between the face ID of each customer and the ID of each business operator (or the physical store operated by the business operator). A customer can preset ID link information in advance by operating a customer terminal 4 (through an information management application), and the entered ID link information is registered in the ID link database 57. As shown in FIG. 7(B), ID link information registered in the ID link database 57 includes a face ID, a business operator ID, a member ID, and other data for each link.

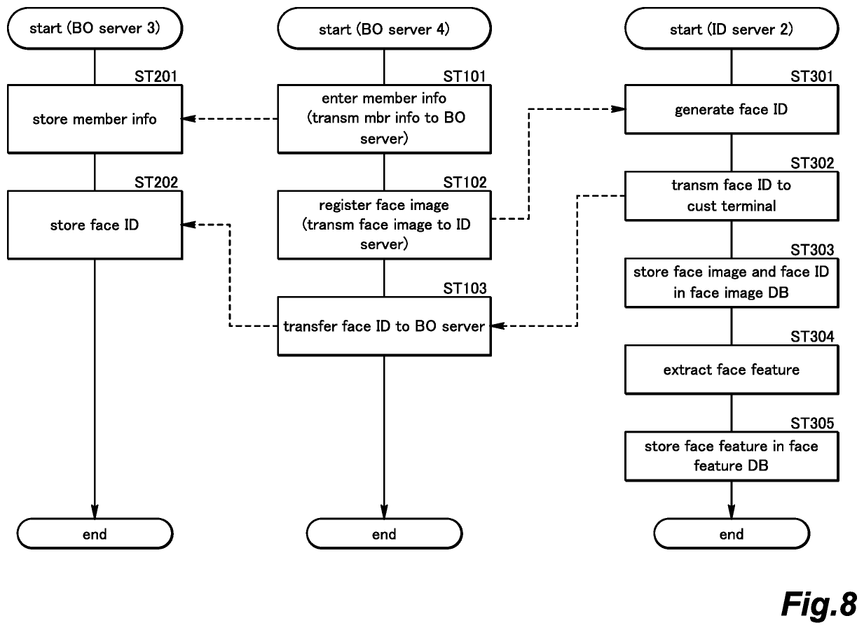

FIG. 8 is a flow chart showing flows of member registration operations performs by a customer terminal 4, a business operator server 3, and an information distribution server 2.

When performing membership registration, a customer (a customer terminal 4) enters member information using a store use application to register themselves as a member for a physical store (ST101). The entered member information is transmitted from the customer terminal 4 to a business operator server 3 and stored in the member registration database 31 of the business operator server 3 (ST201).

In the membership registration, the customer also registers their face image by using a face image registration function of the store use application (ST102). A face image to be registered can be captured by a camera mounted on the customer terminal 4. The captured face image data is transmitted from the customer terminal 4 to the information distribution server 2. In other cases, the customer may use (select) a face image previously stored in the customer terminal 4 instead of using a face image captured by the camera.

The information distribution server 2 generates (assigns) a face ID (face image ID) for identifying face image data received from the customer terminal 4 (ST301). Subsequently, the information distribution server 2 transmits the generated face ID to the customer terminal 4 (ST302), and then the customer terminal 4 transfers the received face ID to the business operator server 3 (ST103).

The business operator server 3 adds the face ID received from the customer terminal 4 to the corresponding member information stored in the member registration database 31 in step ST201 (ST202). As a result, either of the business operator server 3 and the information distribution server 2 can identify a customer by using a face ID without transmitting and receiving face image data of the customer.

The information distribution server 2 stores face image data received from the customer terminal 4 and the face ID assigned to the face image data, in the face image database 51 (ST303). In parallel, the information distribution server 2 extracts a face feature from the face image (ST304) and stores the extracted face feature in the face feature database 52 (ST305). Then, the customer's membership registration operation is completed.

In step ST102 described above, instead of transmitting a face image from the customer terminal 4 to the information distribution server 2, the customer terminal 4 may transmit the face image to the business operator server 3, and then the business operator server 3 may transfer the face image from the server 3 to the information distribution server 2. In this case, the business operator server 3 temporarily stores face image data, and when the transfer of the face image data to the information distribution server 2 is normally completed, the temporarily-stored face image is deleted.

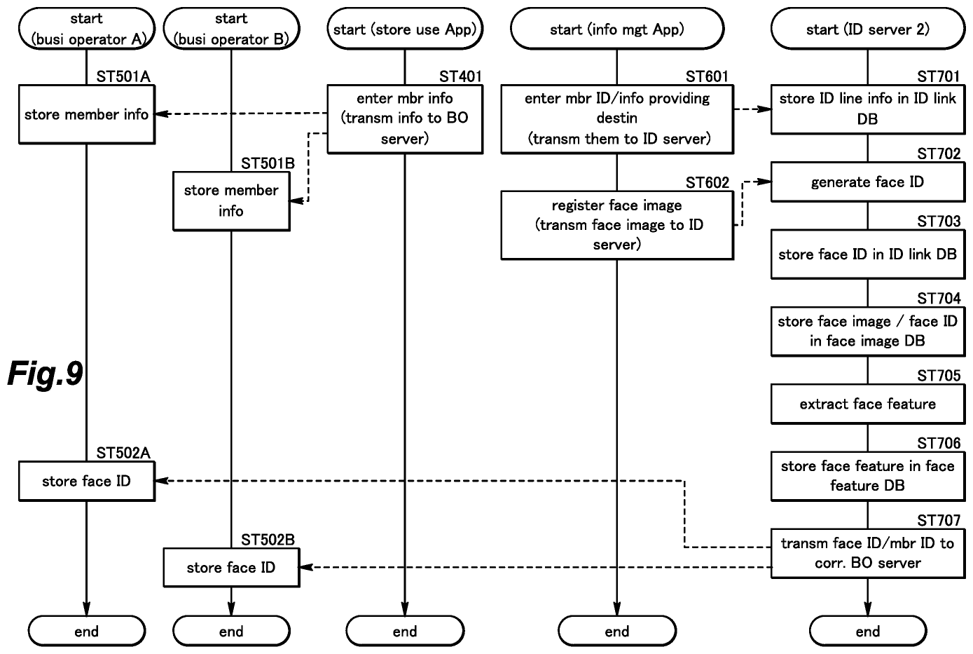

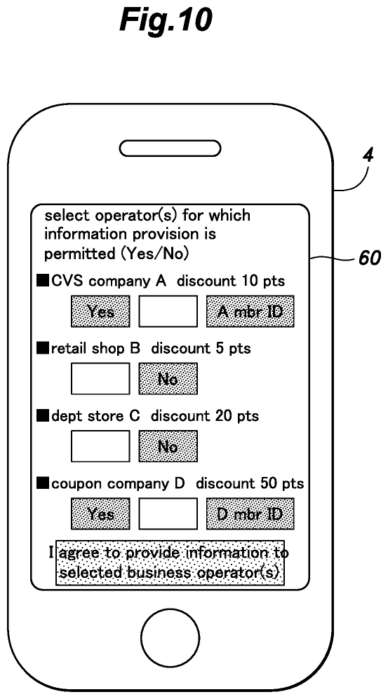

FIG. 9 is a flow chart showing flows of a modification of the member registration operations shown in FIG. 8. FIG. 10 is an explanatory diagram showing an example of an opt-in screen used in step ST601 shown in FIG. 9. Except for what will be discussed here, the modification is the same as the above-described operations shown in FIG. 8.

In the modification shown in FIG. 9, a customer registers a face image in a plurality of business operators at the same time (that is, the business operators shares the face image). The customer registers member information for each business operator by using the store use application in the same manner as the operations in FIG. 8, but is different from FIG. 8 in that the face image is collectively registered by the information management application.

A customer (a customer terminal 4) enters member information using the store use application in the same manner as in step ST101 of FIG. 8 (ST401). In the present embodiment, both a store use application for a business operator A and that for a business operator B are installed on the customer terminal 4, and the member information entered using the two store use applications for the business operators A and B is transmitted from the customer terminal 4 to two business operator servers 3 operated by the business operators A and B, respectively, and stored in the respective member registration databases 31 of the their business operator servers 3 (ST501A, ST501B). Then, the membership registration operation for the two business operators is completed.

The customer enters their member ID and information-providing destinations using the information management application (ST601). The entered member ID and information-providing destinations (business operator IDs) are transmitted to the information distribution server 2.

Subsequently, the information distribution server 2 stores the member ID and the information-providing destinations (including the business operator IDs) received from the customer terminal 4 in the ID link database 57 as ID link information (ST701).

The term “information-providing destination” as used herein refers to a business operator to which a customer permits their information to be provided. For example, as shown in FIG. 10, a customer can select business operators to which the customer permits their information (such as face ID) to be provided, on the opt-in screen displayed on the display 60 of the customer terminal 4. In this example, “convenience store A” and “coupon company D” are selected (Yes) as business operators to which the customer's information is permitted to be provided. The information distribution system 1 may be configured to give discount points to a customer each time the customer selects a predetermined business operator, to thereby encourage the customer to select more business operators on the opt-in screen. Discount points to be given to users may be set by each business operator, notified to the information distribution server, and then displayed on the screen of the information management application.

Next, the customer registers their face image using the face image registration function of the information management application, as in step ST102 of FIG. 8 (ST602). As a result, the face image data is transmitted from the customer terminal 4 to the information distribution server 2.

Subsequently, the information distribution server 2 generates (assigns) a face ID for identifying the face image data received from the customer terminal 4 (ST702). Then, the information distribution server 2 stores the generated face ID in the ID link database 57 (ST703). The face ID is added to the ID link information stored in step ST701 (that is, the face ID is linked to one or more business operator IDs).

The information distribution server 2 performs the process steps ST704-ST705 that are similar to steps ST303-ST305 in FIG. 8, respectively.

Based on the ID link information stored in the ID link database 57, the information distribution server 2 transmits the face ID and the corresponding member IDs set for the business operators, to business operator servers 3 operated by the business operators that are authorized to provide the information to the customer (ST707). Although, in this unlimited embodiment, the transmitted member IDs are different member IDs set for the respective business operator, the common member ID may be shared by different business operators.

Then, each business operator server 3 adds the face ID received from the customer terminal 4 to the customer member information stored in its member registration database 31 in steps ST501A and 501B (ST502A, ST502B).

For the purpose of illustration, FIG. 9 shows the customer's membership registration operation using the store use application and the customer's face image registration operation using the information management application as a series of operations. However, these operations can be independently performed (i.e. at different times).

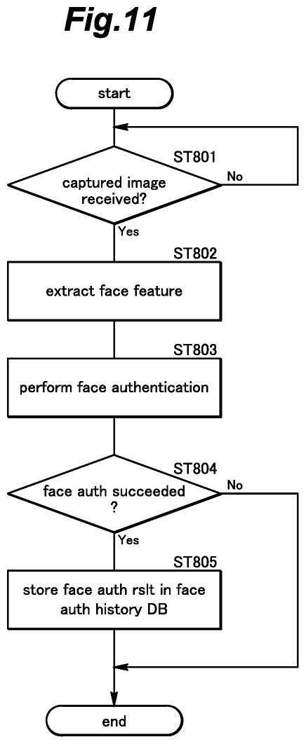

FIG. 11 is a flow chart showing a flow of a face authentication history generation operation performed by an information distribution server 2.

When receiving a captured image from a camera 11 of a physical store (ST801), the information distribution server 2 extracts a face feature from a face image included in the captured image (ST802).

Subsequently, the information distribution server 2 performs face authentication by comparing the face feature extracted in step ST802 with a face feature of the customer's face image registered in advance in a face feature database 52 (ST803).

When the face authentication in step ST803 succeeds (Yes in ST804), the face authentication result is registered in a face authentication history database 53 (ST805). The face authentication enables the information distribution server 2 to identity the person in the captured image (that is, a customer who has visited the physical store).

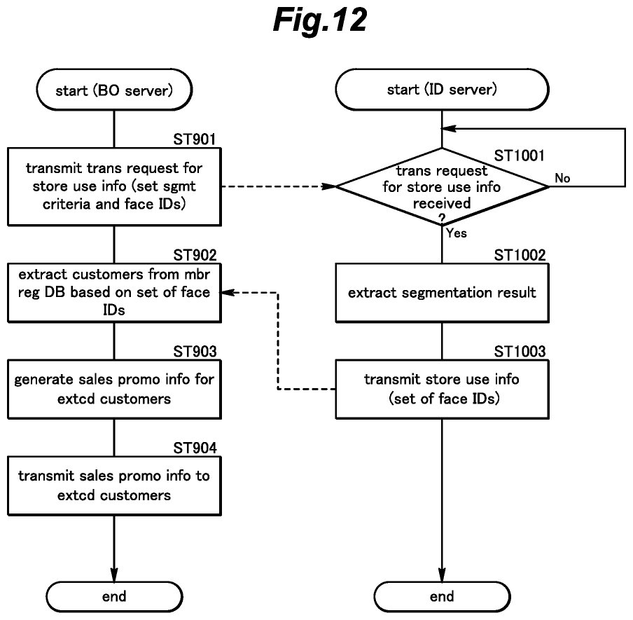

FIG. 12 is a flow chart showing flows of operations for distribution of store use information from an information distribution server 2 to a business operator server 3.

When store use information is necessary, the business operator server 3 transmits a transmission request for store use information to the information distribution server 2 (ST901). The business operator server 3 can transmit a transmission request including a face ID of at least one designated customer, to the information distribution server 2. The designated customer is an existing customer that the business operator has selected as a model (i.e., as a target of sales promotion, or as a reference for sales promotion towards other customers), which is used to extract targets to which sales promotion information is to be transmitted.

In step ST901, the business operator server 3 can transmit information about at least one segmentation criterion (e.g., ID of a segmentation criterion) included in the transmission request, together with or instead of the above-described face ID, to the information distribution server 2.

When receiving the transmission request for store usage information from the business operator server 3 (ST1001: Yes), the information distribution server 2 extracts, corresponding segmentation results (that is, segmentation results including the face ID) from the store use database 56 based on a face ID(s) included in the transmission request (ST1002). Then, the information distribution server 2 extracts a segment (target segment) to which the face ID included in the transmission request belongs, in each segmentation result, and transmits a set of face IDs which belong to the extracted segment, to the business operator server 3 as store use information (ST1003).

When, in step ST1002, the transmission request from the business operator server 3 includes a segmentation criterion together with a face ID, the information distribution server 2 extracts, only from segmentation results corresponding to the segmentation criterion, a segment(s) (target segment(s)) to which the face ID included in the transmission request belongs, and transmits a set of face IDs belonging to the segment(s), to the business operator server 3 as store use information.

When, in step ST1002, the transmission request from the business operator server 3 includes a segmentation criterion, but does not include any face ID, the information distribution server 2, in step ST1003, extracts a set of face IDs related to the segment which includes the largest number of face IDs (of customers) among the segments (segment IDs) in the segmentation results corresponding to the segmentation criterion, and transmits a set of the extracted face IDs, to the business operator server 3 as store use information.

When, in step ST1002, the transmission request from the business operator server 3 does not include any segmentation criterion, the information distribution server 2 may generate a new segmentation criterion, in step ST1003. In this case, the transmission request from the business operator server 3 may include information on a specific action pattern of the customer, which facilitates the generation of a segmentation criterion in the information distribution server 2.

Based on the store use information (a set of face IDs) received from the information distribution server 2, the business operator server 3 extracts the corresponding customers (that is, the members having the face IDs included in the store use information) from the member registration database 31 (ST902).

Subsequently, the business operator server 3 generates sales promotion information (such as targeted advertisements) for the extracted customers (ST903), and transmits the generated sales promotion information to the customers by e-mail or other notification means (ST904).

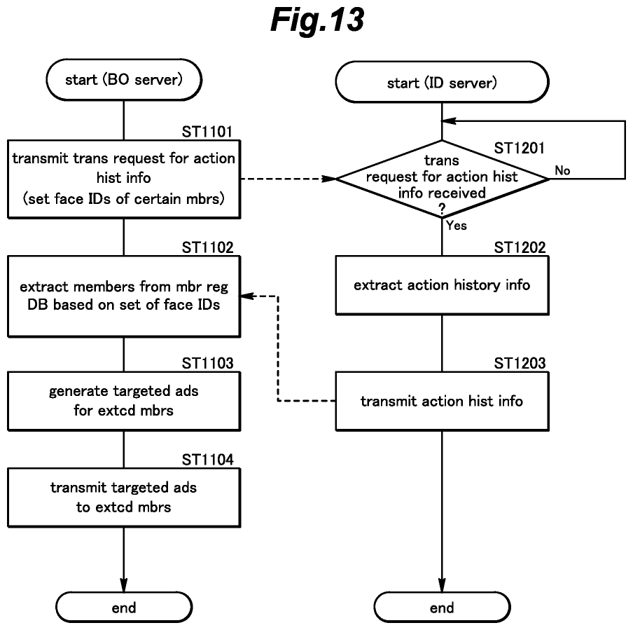

FIG. 13 is a flow chart showing flows of operations for action history information distribution from an information distribution server to a business operator server.

When action history information as store use information on a specific customer is necessary, the business operator server 3 transmits a transmission request for action history information, to the information distribution server 2 (ST1101). The transmission request includes a face ID for the specific customer.

When the information distribution server 2 receives the transmission request for action history information from the business operator server 3 (ST1201: Yes), the information distribution server 2 extracts action history information on the customer having the corresponding member ID, from the action history database 54 based on the face ID included in the transmission request (ST1202).

Then, the information distribution server 2 transmits the extracted action history information to the business operator server 3 (ST1203).

The business operator server 3 generates, based on the action history information received from the information distribution server 2, sales promotion information (such as target advertisement) for the specific customer (ST1103), and transmits the generated sales promotion information to the specific customer by e-mail or any other notification means (ST1104).

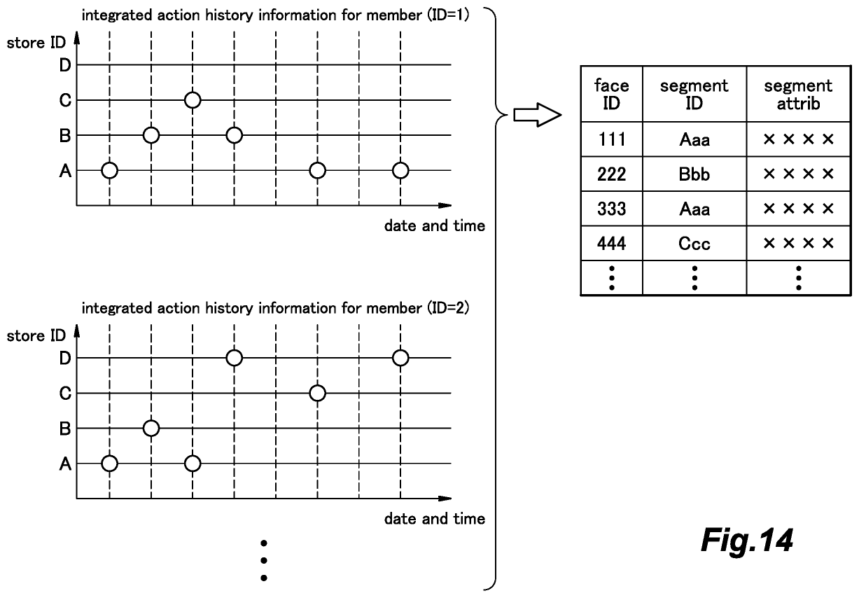

FIG. 14 is an explanatory diagram showing an example of a customer segmentation operation performed by an information distribution server 2.

The information distribution server 2 performs, as a customer segmentation operation, a statistical processing operation on action history information for each customer registered in the action history database 54.

In the statistical processing operation, the information distribution server 2 performs a classification operation (segmentation or clustering) by analyzing action history information for each person based on a predetermined segmentation criterion. Specifically, based on the action history pattern of each customer (such as a frequency of visits to a specific store, a pattern of visits to multiple stores, and a frequency of touching a specific item) and/or the attributes (such as age and gender), the information distribution server 2 extracts a group of persons having a predetermined action history pattern or an attribute to thereby generate one segment (a set of persons); or classifies (clusters) persons having a similar action history pattern and attributes, as persons of the same segment. Such a predetermined segmentation criterion may be not only a criterion for designating an action history pattern or attribute, but also a criterion of “a segment having an action history pattern or attribute similar to a certain person with a specified face ID.” Alternatively, instead of a criterion of designating a person, a criterion of “a segment having an action history pattern or attribute of XX” is also possible.

FIG. 14 illustrates an example based on a segmentation criterion of the customer's action history pattern, where the horizontal axis represents the date and time of a customer's store visits to a physical store, and the vertical axis represents the store ID (A, B, C, D . . . ) for identifying each physical store. From the graph, it is possible to recognize what types of physical store each customer has visited in the past in what order and at what time interval as a time-series action history pattern (a stop-by pattern of a plurality of stores).

In this example, the information distribution server 2 can group (cluster) customers based on the similarity of shapes of time-series patterns (the distance between the polygonal lines, which are the time-series patterns), each time-series pattern expressing each customer's pattern of dropping in multiple stores, and assign the customers of each group to a corresponding segment. In the present embodiment, the information distribution server 2 gives each segment ID to the customers of a corresponding group and registers the segment ID in the action history database 54.

The information distribution server 2 may perform the customer segmentation operation using a model created by machine learning technology. In this case, the effect of sales promotion measures provided by the business operator server 3 is used to train the machine learning model, so that the optimal segmentation can be achieved by using action history information on a specific customer, as input information to the machine learning model. Specifically, by using the store use information generated under a certain segmentation criterion, the information distribution server 2 measures the “sales promotion effect” (the sales, the number of visitors to a store, the coupon usage rate, and the combined sales rate of items associated with coupons) achieved by sales promotion information generated by the customer information distributor 23 of the business operator server 3, and trains the model by using a neural network or other technology to thereby create a machine learning model which can be used to recognize how the sales promotion effect is maximized when action history information of a certain customer is given; that is, to determine what segmentation criterion should be used for segmentation (what kind of person group should be extracted as a set of similar persons to the certain customer) to maximize the sales promotion effect.

Specific embodiments of the present disclosure are described herein for illustrative purposes. However, the present disclosure is not limited to those specific embodiments, and various changes, substitutions, additions, and omissions may be made for elements of the embodiments without departing from the scope of the present disclosure. In addition, elements and features of the different embodiments may be combined with each other to yield an embodiment which is within the scope of the present disclosure.

### INDUSTRIAL APPLICABILITY

A store use information distribution device, a store use information distribution system equipped with the same, and a store use information distribution method according to the present disclosure achieve an effect of allowing a business operator that operates a physical store to identify each customer and acquire related store use information at the physical store, without any need for management of customers' face images at each store, and are useful as a store use information distribution device, a store use information distribution system equipped with the same, and a store use information distribution method for providing store use information about customers' usage of a physical store.

### Glossary

1 information distribution system (store use information distribution system)
2 information distribution server (store use information distribution device)
3 business operator server (business operator device)
4 customer terminal
5 staff terminal
6 network
11 camera
12 POS terminal
13 touchpoint terminal
21 member registrator
22 POS information collector
23 customer information distributor
24 staff information distributor
31 member registration database
32 purchase history database
33 sales promotion information database
41 captured image collector
42 face image processing controller
43 face authenticator controller
44 touchpoint information collector
45 POS information collector
46 store visit information acquirer
47 action analyzer
48 store use information generator
51 face image database
52 face feature database
53 face authentication history database
54 action history database (action history storage)
55 segmentation criterion database
56 store use database
57 ID link database
60 display

1. A store use information distribution device communicably connected to at least one business operator device for managing member information about customers of a physical store, and configured to provide the business operator device with store use information about customers' usage of the physical store, the store use information distribution device comprising:
a processor; and
an action history storage for storing action history information about actions of the respective customers in the physical store;
wherein the processor is configured to:
acquire face images of the respective customers;
generate face image IDs for identifying the respective face images of the customers;
transmit each of the face image IDs to the business operator device;
perform a customer segmentation operation on the action history information based on one or more segmentation criteria related to the customers' usage of the physical store, to thereby assign the customers to one or more segments; and
generate a set of face IDs of customers assigned to at least one of the segments and transmit the set of face image IDs to the business operator device as the store use information.

2. The store use information distribution device according to claim 1, wherein the processor is configured to transmit the store use information to the business operator device in response to a transmission request from the business operator device.

3. The store use information distribution device according to claim 2, wherein the transmission request includes a face image ID of at least one customer, and
wherein the processor is configured to:
extract at least one segment to which the at least one customer whose face image ID is included in the transmission request belongs, as a target segment; and
transmit a corresponding set of face IDs of customers assigned to each target segment to the business operator device as the store use information.

4. The store use information distribution device according to claim 2, wherein the transmission request includes a segmentation criterion ID for identifying the segmentation criterion, and
wherein the processor is configured to perform the customer segmentation operation on the action history information based on a segmentation criterion corresponding to the segmentation criterion ID included in the transmission request.

5. The store use information distribution device according to claim 1, wherein a customer terminal carried by a customer stores an application program for registration of the member information, and wherein the processor acquires a face image of the customer via the application program.

6. The store use information distribution device according to claim 1, wherein a camera is installed in the physical store, and is configured to capture face images of the customers.

7. The store use information distribution device according to claim 1, wherein the processor transmits the store use information only to a permitted business operator device which is selected by a customer from the at least one business operation device, and to which the store use information is permitted to transmitted.

8. A store use information distribution system comprising:
the store use information distribution device according to claim 1; and
the at least one business operator device for managing the member information about the customers of the physical store.

9. The store use information distribution system according to claim 8, wherein the business operator device, based on the store use information, distributes sales promotion information which can increase purchase motivation of a target customer, to at least one of a customer terminal carried by the target customer and a staff terminal carried by a staff member of the physical store.

10. The store use information distribution system according to claim 8, further comprising a touchpoint terminal which is installed in the physical store so that the customers can use the touchpoint terminal, and
wherein the action history information includes touchpoint information indicating that the customers use the touchpoint terminal to view and check information on a specific item or a specific service.

11. A store use information distribution method, wherein the method is performed by a store use information distribution device communicably connected to at least one business operator device for managing member information about customers of a physical store, and configured to provide the business operator device with store use information about customers' usage of the physical store, the method comprising:
storing action history information about actions of the respective customers in the physical store;
acquiring face images of the respective customers;
generating face image IDs for identifying the respective face images of the customers;
transmitting each of the face image IDs to the business operator device;
performing a customer segmentation operation on the action history information based on one or more segmentation criteria related to the customers' usage of the physical store, to thereby assign the customers to one or more segments; and
generating a set of face IDs of customers assigned to at least one of the segments and transmitting the set of face image IDs to the business operator device as the store use information.
